(19) United States
(12) Patent Application Publication
(10) Pub. No.: US 2013/0271386 A1
(43) Pub. Date: Oct. 17, 2013

(54) ELECTRONIC DEVICE HAVING HANDWRITING INPUT FUNCTION

(71) Applicants: TEN-CHEN HO, Tu-Cheng (TW); XIAO-LIAN HE, Shenzhen City (CN)

(72) Inventors: TEN-CHEN HO, Tu-Cheng (TW); XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/523,957

(22) Filed: Jun. 15, 2012

(30) Foreign Application Priority Data
Apr. 12, 2012 (CN) 201210106178.5

(51) Int. Cl. G06F 3/033; G06F 3/041

(52) U.S. Cl. 345/173

(57) ABSTRACT

An electronic device includes a handwriting pen and a main body. A gyroscope senses movement information of the handwriting pen and outputs the movement information to a controller. The controller converts the movement information into electrical signals and outputs the electrical signals to the main body through a signal transmitting module. A processor receives the electrical signals through a signal receiving module and the signal transmitting module, converts the electrical signals into movement information, and outputs the movement information to a character identification module. The character identification module converts the movement information into a corresponding character, and controls the display unit to display the character.

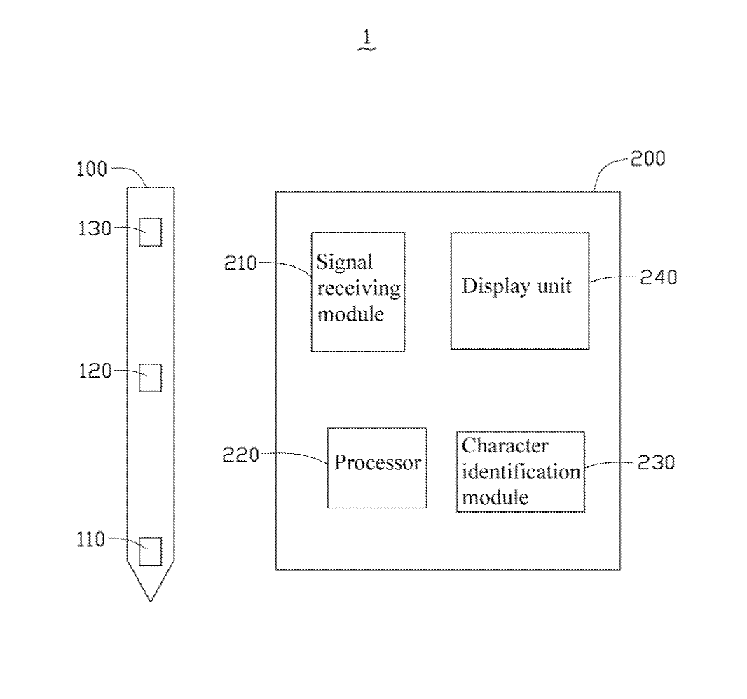

### BACKGROUND

1. Technical Field

The present disclosure relates to electronic devices, and particularly to an electronic device having a handwriting input function.

2. Description of Related Art

Handwriting input methods consist of handwriting with a pen or a finger, on a display unit of the electronic device. However, the pen tip or fingernails may scratch the display unit of the electronic device. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a schematic diagram of an electronic device having handwriting input function in accordance with an exemplary embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

The FIGURE, is an electronic device 1 in accordance with an exemplary embodiment including a handwriting pen 100 and a main body 200. The handwriting pen 100 includes a gyroscope 110, a controller 120, and a signal transmitting module 130. The gyroscope 110 is set in a bottom end of the handwriting pen 100. The controller 120 is set in a center of the handwriting pen 100. The signal transmitting module 130 is set in a top end of the handwriting pen 100. The gyroscope 110 senses movement information, such as movement paths, movement distances, and movement speeds of the handwriting pen 100, and sends the movement information to the controller 120. The controller 120 converts the movement information into electrical signals and sends the electrical signals to the main body 200 through the signal transmitting module 130. In one embodiment, the signal transmitting module 130 is a wireless signal transmitting module.

The main body 200 includes a signal receiving module 210, a processor 220, a character identification module 230, and a display unit 240. In one embodiment, other elements of the electronic device 1 are well-known elements of a general electronic device. The processor 220 receives the electrical signals from the handwriting pen 100 through the signal receiving module 210 and the signal transmitting module 130, converts the electrical signals into movement information, and sends the movement information to the character identification module 230. The character identification module 230 converts the movement information into a corresponding character, and controls the display unit 240 to display the character. In the embodiment, the signal receiving module 210 is a wireless signal receiving/transmitting module.

In use, a character, such as “one”, can be written in air by the handwriting pen 100 when a button (not shown) set on the handwriting pen 100 is pressed. The gyroscope 110 senses the movement information of the handwriting pen 100 and sends the movement information to the controller 120. The controller 120 converts the movement information into electrical signals and sends the electrical signals to the processor 220 of the main body 200 through the signal transmitting module 130 and the signal receiving module 210. The processor 220 converts the electrical signals into the movement information and sends the movement information to the character identification module 230. The character identification module 230 converts the movement information into a corresponding character, such as “one”, and controls the display unit 240 to display the character.

The electronic device 1 does not require the handwriting pen 100 to directly touching the display unit 240 of the main body 200. Therefore, the display unit 240 can avoid being scratched by the handwriting pen 100 when data is inputted by the handwriting pen 100.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An electronic device, comprising:
a handwriting pen comprising:
a wireless signal transmitting module;
a gyroscope to sense movement information of the handwriting pen and output the movement information; and
a controller to receive the movement information from the gyroscope, convert the movement information into electrical signals, and output the electrical signals through the signal transmitting module; and
a main body comprising:
a display unit;
a wireless signal receiving module;
a processor to receive the electrical signals from the handwriting pen through the signal receiving module and the signal transmitting module, convert the electrical signals into movement information, and output the movement information; and
a character identification module to receive the movement information from the processor, convert the movement information into a corresponding character, and control the display unit to display the character.
